(19) United States
(12) Patent Application Publication
(10) Pub. No.: US 2020/0245427 A1
(43) Pub. Date: Jul. 30, 2020

(54) Type Artificial Tree

(71) Applicant: Te Hui Lin, Chu Pei City (TW)

(72) Inventor: Te Hui Lin, Chu Pei City (TW)

(21) Appl. No.: 16/773,330

(22) Filed: Jan. 27, 2020

(30) Foreign Application Priority Data
Jan. 25, 2019 (TW) 108201290

(51) Int. Cl. H05B 45/20; H05B 45/10; H05B 47/19; F21S 4/15

(52) U.S. Cl. CPC H05B 45/20; H05B 45/10; F21W 2121/04; F21S 4/15; H05B 47/19

(57) ABSTRACT

Provided is a new type artificial tree including a light string having RGB, WRGB or WWRGB LEDs each containing an individual built-in address chips, a controller having settings that would control a lights brightness, dimmer, and color change; a tree having a pillar to hold the tree and the light strings or light layers, wherein the new type artificial tree can present different words of figures or a combination of words and figures which can be animated to improve holiday atmosphere.

### TECHNICAL FIELD

This invention relates to an artificial tree and a lighting mechanism that utilizes individual built-in address chips to control each individual RGB LED, WRGB LED, WWRGB LED (W represents white light LED that emit either warm white light or cold white light, while WW represents white light LED that can emit warm and cold white light), etc. which forms the light string on specific addresses on the tree (can either be an artificial tree or an real tree), to mark the specific addresses and order of each LED bulb.

Using a controller to send electric power and command, and control each or multiple bulb's brightness, color change, etc. to allow the tree to light up different designs, lettering, animation, etc.

### BACKGROUND OF THE INVENTION

It is common for traditional artificial tree to warp LED light string around the tree, and current LED production technology is very advanced, where RGB, WRGB and WWRGB LED with built in individual addresses that can be individually controlled is commonly utilized in the previously mentioned artificial trees.

However, the artificial trees that utilizes the aforesaid LED light strings do not exercise the full potential of the LED light strings, because the traditional LED light strings are still being randomly wrapped around the artificial trees (referred as the “traditional method”), and said traditional method limits the color change or brightness dimmer or flashing to can only be performed in block areas, providing inferior visual effects and cannot show words or figures, not to mention unable to show words and figures or animations at the same time. Unable to exploit the advantages of the LED light strings.

As the limitations mentioned above, the traditional artificial trees sold on the current market cannot show words, figures or both words and figures combined in animation. The main goal of this invention is to provide a lighting mechanism that utilizes individual built-in address chips to control each individual RGB LED, WRGB LED, WWRGB LED light string, and combine it with artificial trees to break through the limitations of the traditional method and achieve a artificial tree with a diverse expression, which will not just beautify the lighting theme of the tree, but further allow the tree to be able to express words and figures and further more combine works and figures into animation, etc. and allow this invention to have a greater visual effect.

### BRIEF DESCRIPTION OF THE DRAWINGS

FIG. 1 shows the connection between the power source, control system, and light bulbs.

FIG. 2 shows the location of light bulbs on each light layer parallel to the floor.

FIG. 3 shows the location of light bulbs one each light layer diagonal to the floor.

FIG. 4 shows the location and number of each light layer from the front and top view.

FIG. 5 is the front and zoom in view of the distribution and number of light layers of FIG. 4.

FIG. 6 is the top and zoom in view of the distribution and number of light layers of FIG. 4.

FIG. 7 shows the distribution and numbering of each light layer in an alternative method of implementation using slope light layers from the front and top view.

FIG. 8 shows zoom of the front view of the location and distribution of each light layers in FIG. 7.

FIG. 9 shows zoom of the top view of the location and distribution of each light layers in FIG. 7.

FIG. 10 shows the top and front view of horizontal circulation of the light string around the tree's horizontal light layer.

FIG. 11 shows the zoom of the front view of FIG. 10.

FIG. 12 shows the zoom of the top view of FIG. 10

FIG. 13 shows the top and front view of slope circulation of the light string around the tree's slope light layer.

FIG. 14 shows the zoom of the front view of FIG. 13

FIG. 15 shows the zoom of the top view of FIG. 13.

FIG. 16 shows the front and top view Mickey Mouse implementation of this invention.

FIG. 17 shows the zoom view of FIG. 16.

FIG. 18 shows the front and top view Deer implementation of this invention.

FIG. 19 shows the zoom view of FIG. 18.

FIG. 20 shows the front and top view Hart implementation of this invention.

FIG. 21 shows the zoom view of FIG. 20

FIG. 22 shows the top and front view of the “Marry Christmas” implementation.

FIG. 23 shows the top and front view of FIG. 22 after the words start rotating around the tree.

FIG. 24 shows the top and front view of FIG. 22 after the words after further rotation around the tree.

FIG. 25 shows the outer layer circumference and interior layer circumference of the tree.

### REFERENCE NUMERALS

1 . . . Light Module System
11 . . . Power Source
13 . . . Light Bulb
2 . . . Tree
21 . . . Design on Tree
3 . . . Light String
31 . . . Light Layer
4 . . . Pillar
A . . . View Angle
LAY . . . Slope Light Layers
C . . . Outer Layer Circumference
C2 . . . Cn . . . Interior Layer Circumference
S . . . Slant Side
CL . . . Controller
N . . . Number
P . . . Plain

### DETAILED DESCRIPTION OF THE INVENTION

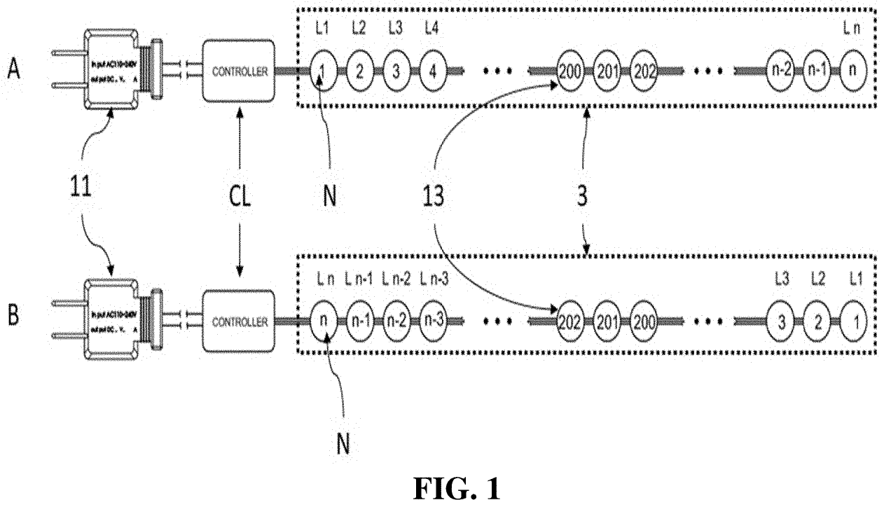

FIG. 1A shows a lighting string mechanism formed with RGB LED, WRGB LED, WWRGB LED bulbs with individual built-in location chips to control each individual, where each LED light bulb on lighting string 3 is issued and individual address number L1 . . . Ln, starting from the side with controller CL, the first LED bulb L1 is number 1, the second LED bulb L2 is number 2, the third LED bulb L3 is number three and so on till the n^{th} LED bulb Ln is number n. While in FIG. 1B, is the opposite of FIG. 1A, where starting from the side with controller CL, the first LED bulb Ln is number n, the second LED bulb Ln−1 is number n−1, the third LED bulb Ln−2 is number n−1 and so on till the last LED bulb L1 is number 1.

The installation of said invention is based on the needs of the user, and installs the LED light bulbs at the required addresses and control the lighting based on its address to reach the above mentioned effects. The following is one example of the implementation:

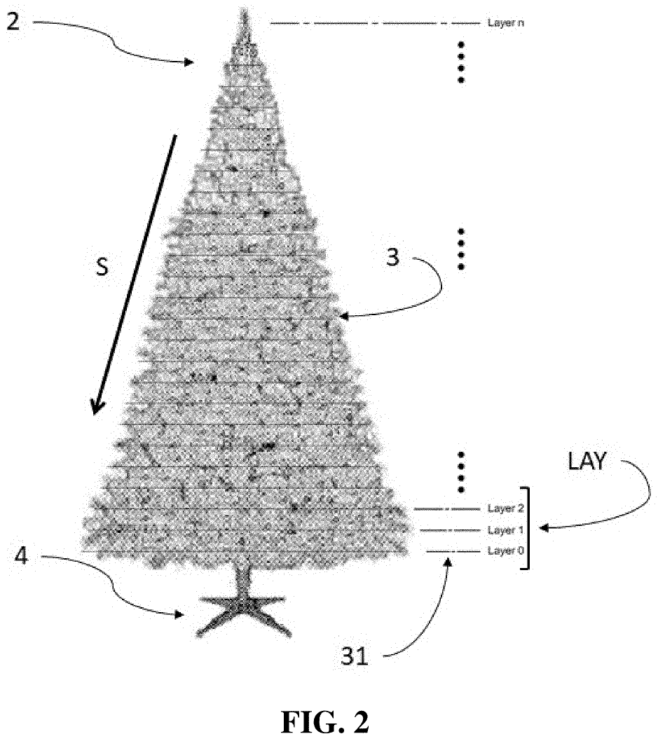

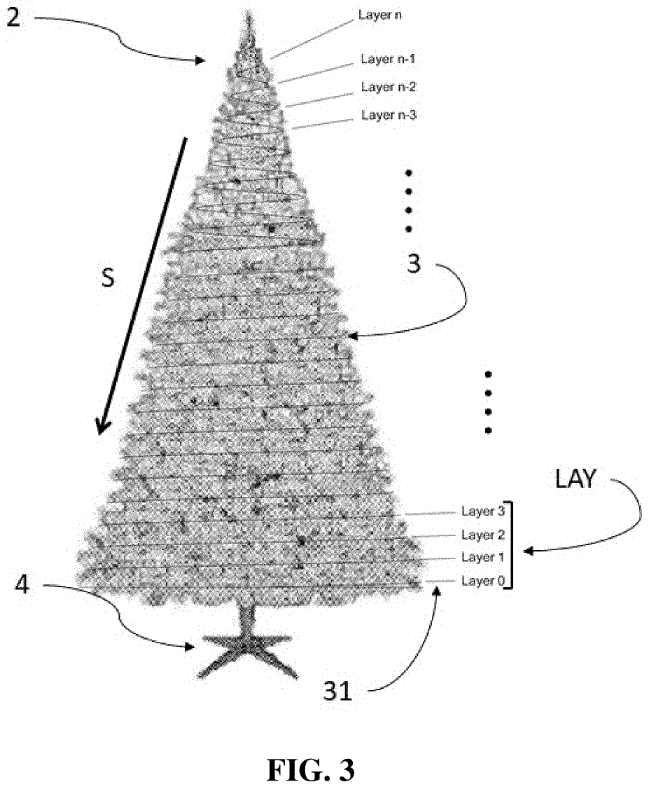

FIG. 2 shows that this invention can change the implementation of light bulbs based on the different sizes of tree 2 (can either be craft tree or natural tree) and number of bulbs in light string 3. Firstly divide tree 2 into multiple rows of light row 31, and each light row 31 is parallel with the floor, and is divided into layer 0, layer 1, layer 2, . . . to layer n, or as shown in FIG. 3, circulates diagonally implemented on tree 2, and divide tree 2 into different slope layers LAY (layer 0, layer 1, layer 2, . . . to layer n).

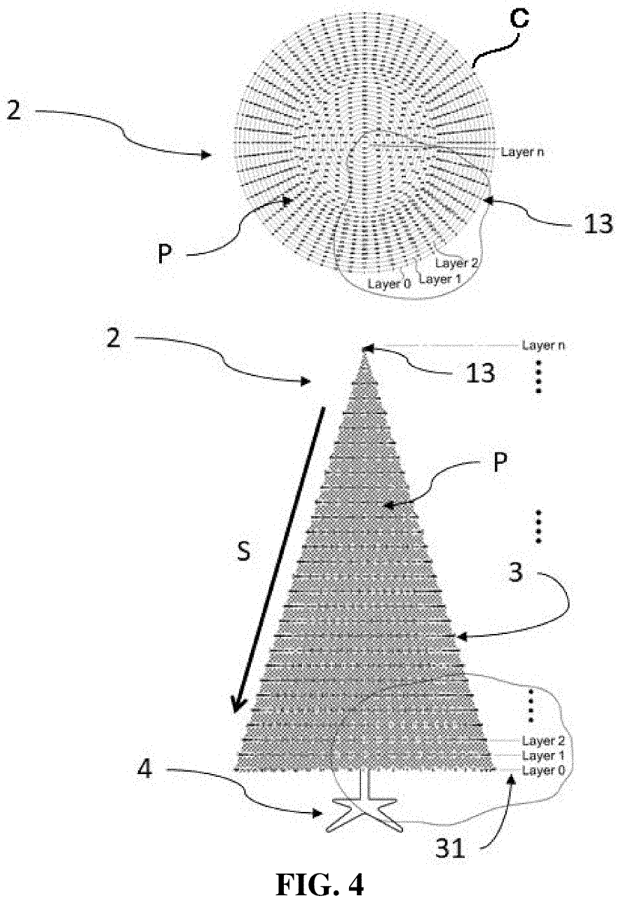

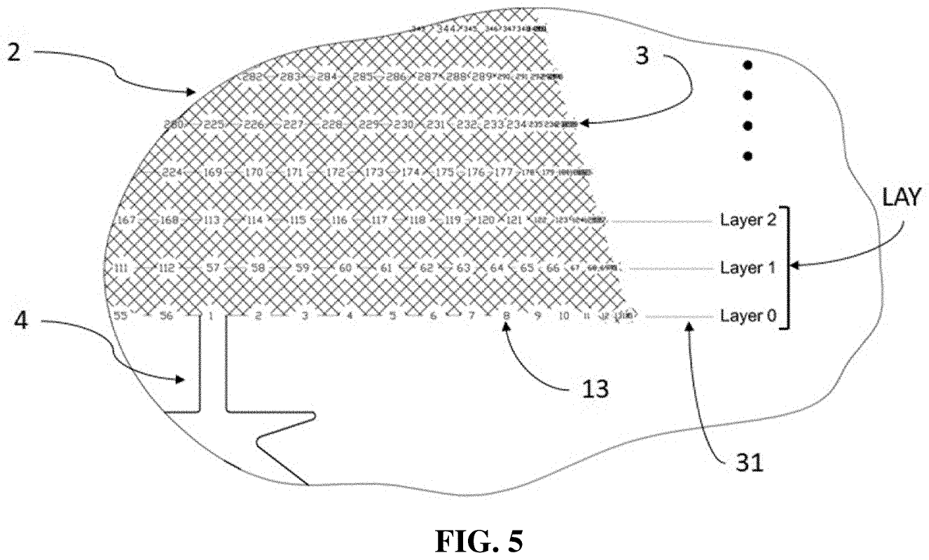

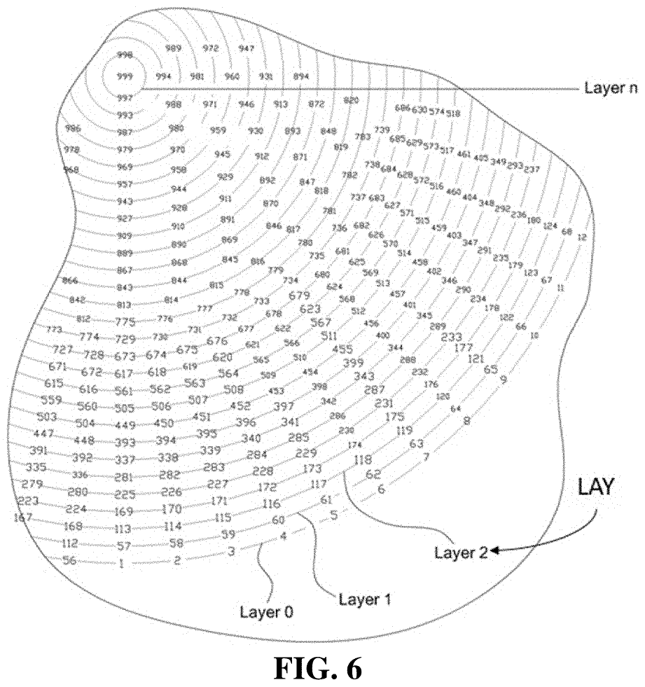

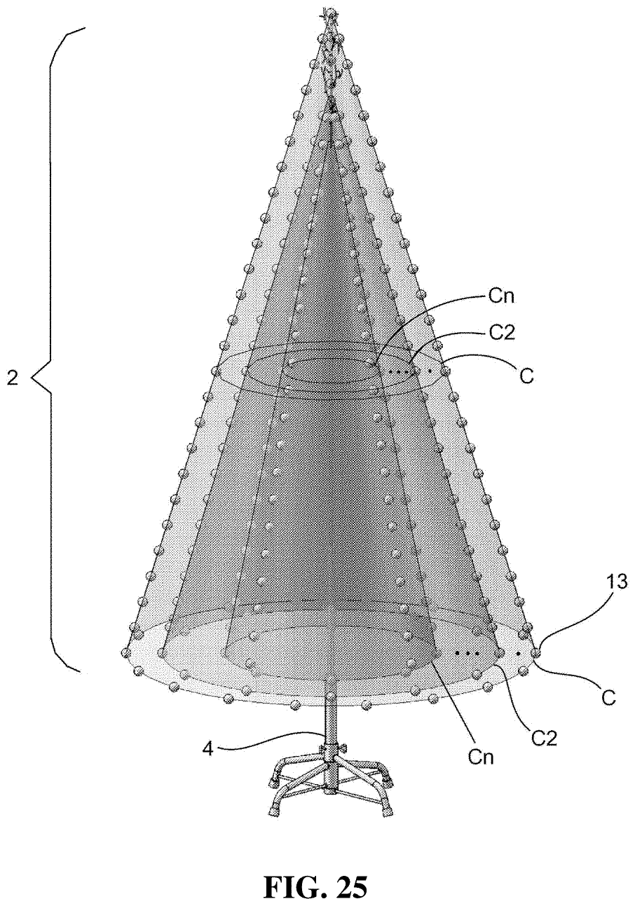

Looking at FIG. 4, FIG. 5, and FIG. 6, light string 3 circulates horizontally around each light layers LAY's circumference C (or as shown in FIG. 25, circulates around inside the tree with different circumferences C2 to Cn), and set up LED address numbers N relative to LED locations, where light layer LAYO (Layer 0) with address numbers N 1˜48; Light Layer LAY1 (Layer 1) contains address numbers N 49˜94; Light layer LAY2 (Layer 2) contains address numbers 95˜138 and so on, where the bulbs would be located on the outer circumference C of surface P of each Light Layer 31.

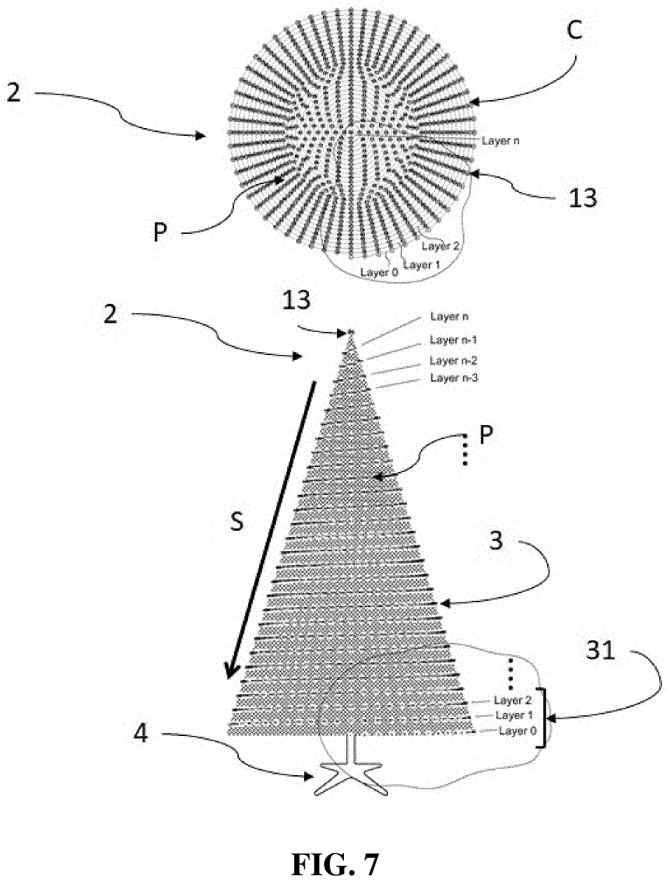

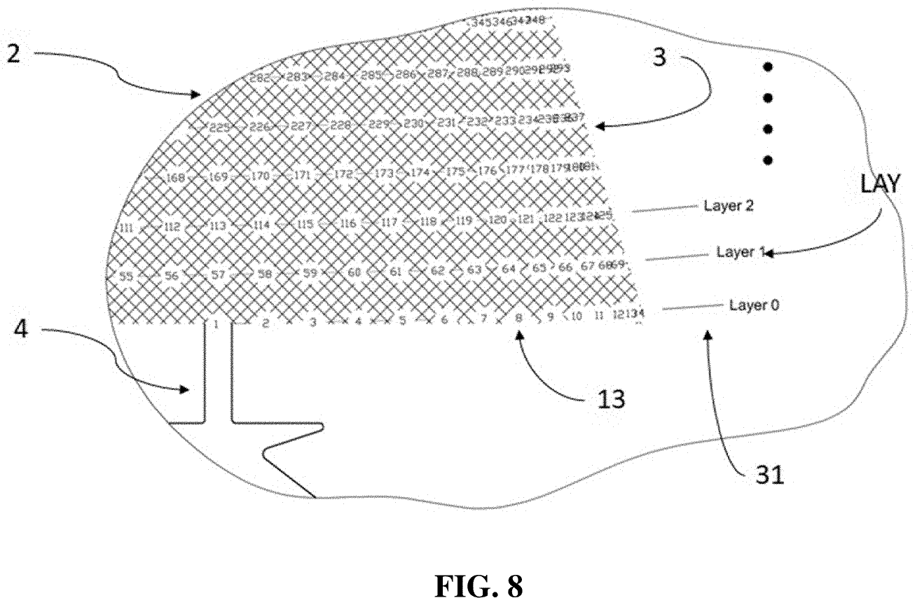

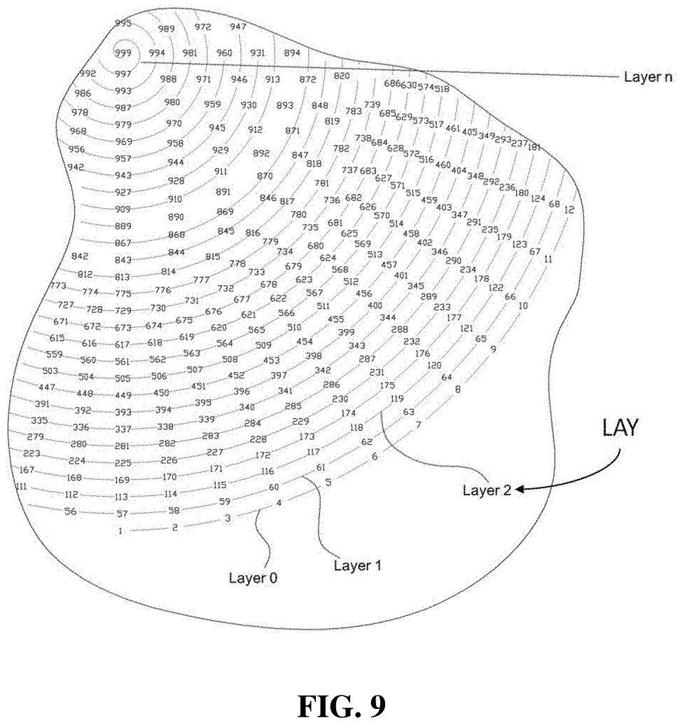

Looking at FIG. 7, FIG. 8, and FIG. 9, light string 3 circulates diagonally around each diagonal light layers LAY's circumference C (or as shown in FIG. 25, circulates around inside the tree with different circumferences C2 to Cn), and set up LED address numbers N relative to LED locations, where light layer LAYO (Layer 0) with address numbers N 1˜48; Light Layer LAY1 (Layer 1) contains address numbers N 49˜94; Light layer LAY2 (Layer 2) contains address numbers 95˜138 and so on, where the bulbs would be located on the outer circumference C of each Light Layer 31.

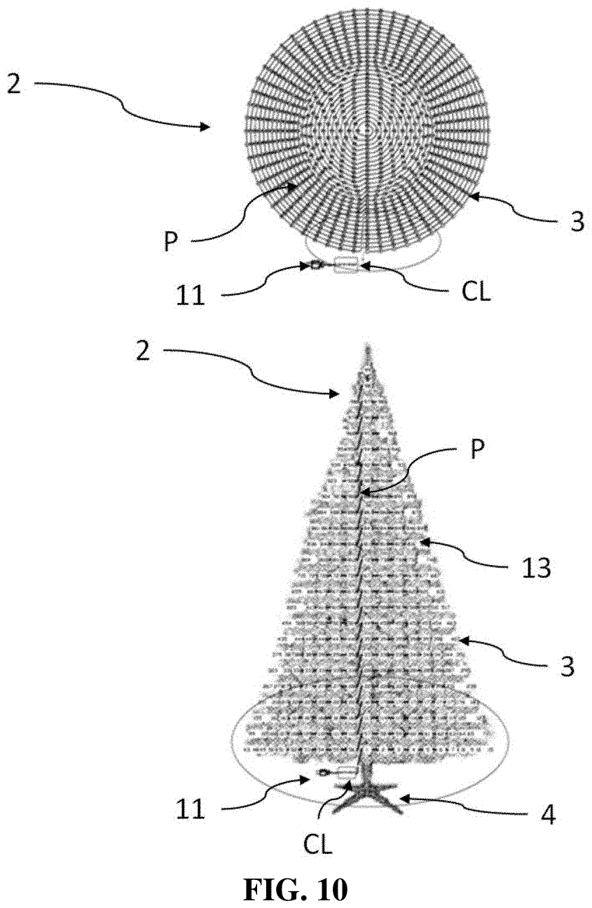

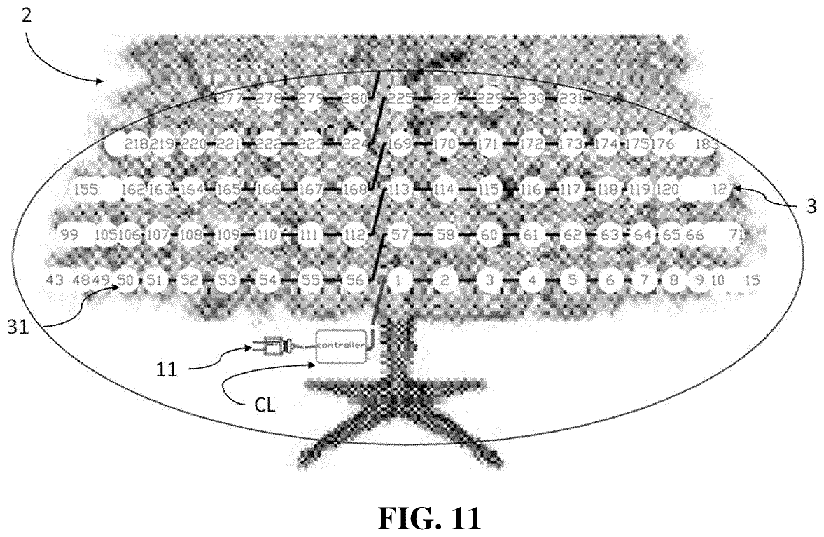

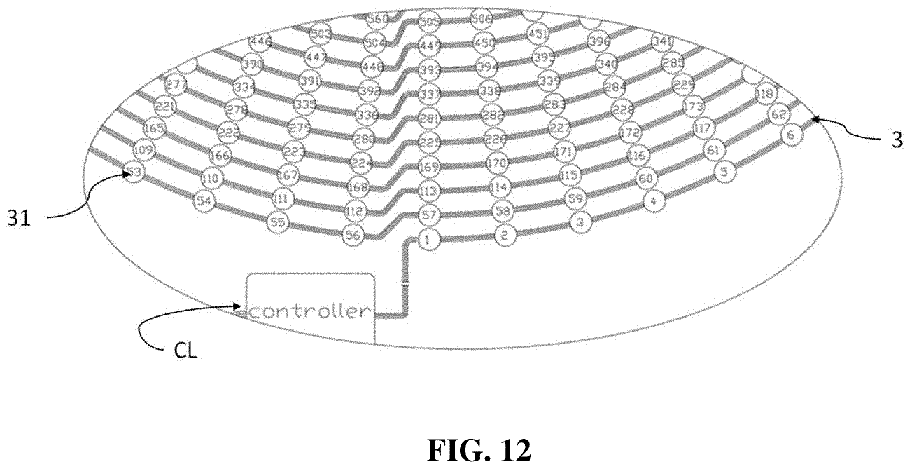

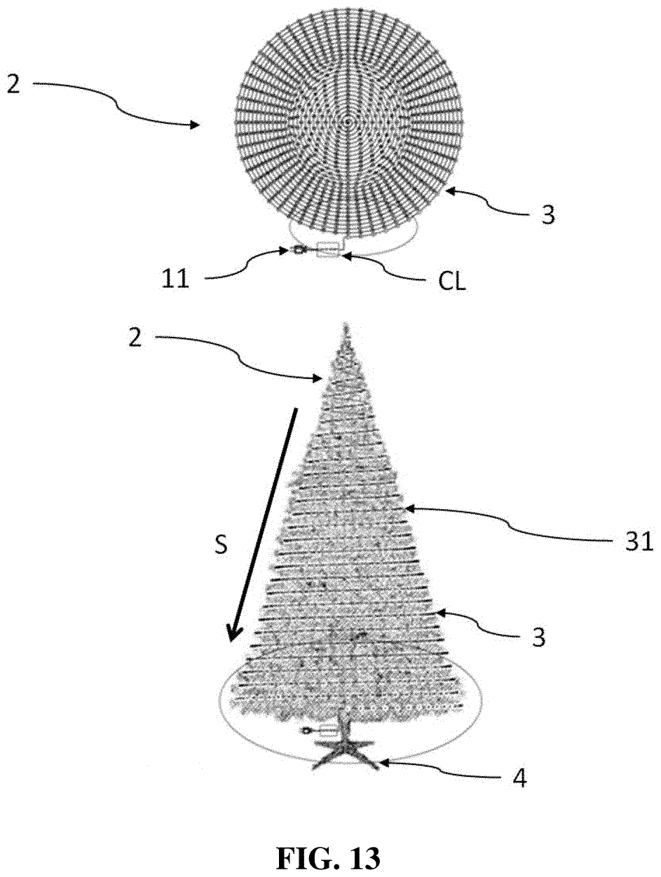

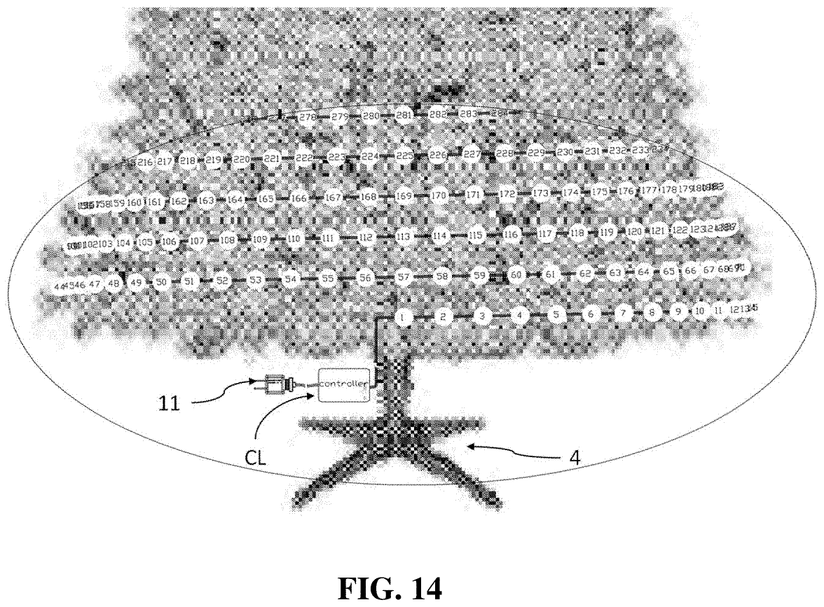

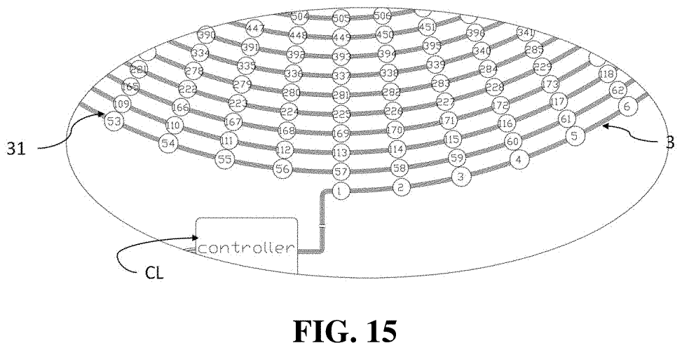

Looking at FIG. 10, FIG. 11, and FIG. 12, light string 3 extends from Tree 2, and is circulated horizontally parallel to the floor around Tree 2, where the number 1˜48 light bulbs of Light String 3 is fixed on the relative locations (Address Number N 1˜48) on Layer 0 (Light Layer 0); the number 49˜94 light bulbs of Light String 3 is fixed on the relative locations (Address Number N 49˜94) on Layer 1 (Light Layer 1); the number 95˜138 light bulbs of Light String 3 is fixed on the relative locations (Address Number N 95˜138) on Layer 2 (Light Layer 2) and so on. Similarly, in FIG. 13, FIG. 14, and FIG. 15, light string 3 extends from Tree 2, and is circulated diagonally on slope S around Tree 2, where the number 1-48 light bulbs of Light String 3 is fixed on the relative locations (Address Number N 1˜48) on Layer 0 (Light Layer 0) of slope S; the number 49˜94 light bulbs of Light String 3 is fixed on the relative locations (Address Number N 49˜94) on Layer 1 (Light Layer 1) of slope S; the number 95˜138 light bulbs of Light String 3 is fixed on the relative locations (Address Number N 95˜138) on Layer 2 (Light Layer 2) of slope S and so on, which installs each bulb of Light String 3 at the relative locations on Tree 2, therefore each diagonal light layer LAY each has LED lights with individual locating number N and after having a fixed address on Tree 2, the individual lights can then be controlled by Controller CL, and present on Tree 2 the designed images through controlling the light intensity and color change of each individual LED, and finally present word, or figures or a combination or alternation of words and figures to form animations.

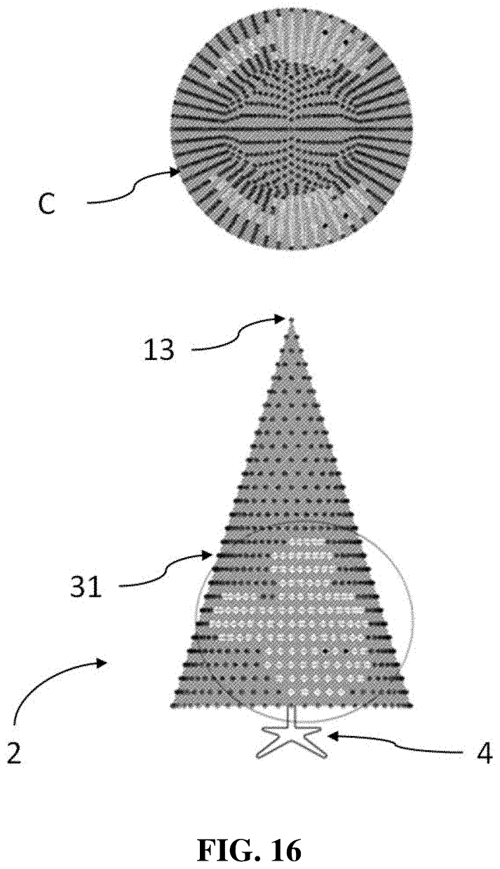

Furthermore looking at FIGS. 10 to 15 is used to explain one method of implementation, FIGS. 16 to 22 shows other methods of implementation with figures showing a zoom in view of the different designs on Tree 2, showing exterior LED lights and number N is an enlarged view so that the reader can better understand, hence it is not in proportion to Tree 2. In reality, this invention's LED lights on Tree 2 can be of any shape, size and design, can even have no protective layer, and not limited by the Figures presented.

### Best Mode

As mentioned above, said invention is implemented by installing RGB or WRGB LED with individual address chips on the relative locations of Tree 2, then using controller CL to control each individual LED's on-off, brightness and color change to show different displays on Tree 2.

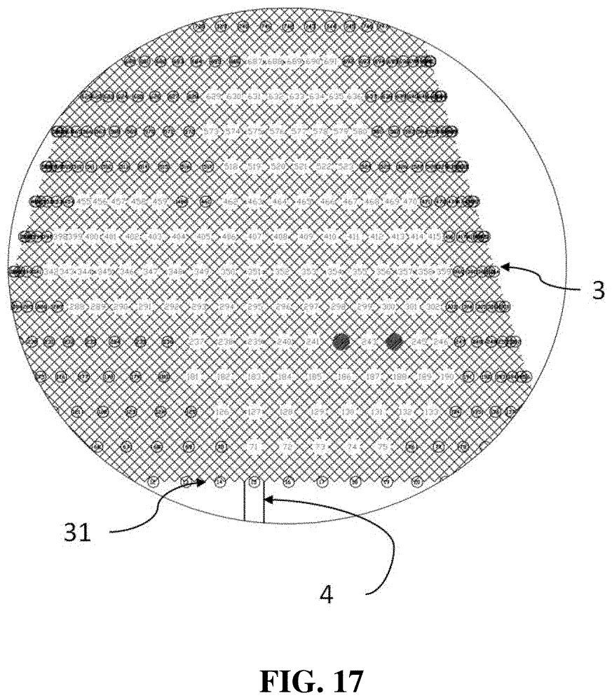

Implementation 1: Please refer to FIGS. 16 and 17 for the following implementation example, this example shows a display of a Mickey Mouse figure, where the command to present the Mickey Mouse figure is set, and a signal is sent to LEDs with specific addresses to light up, said Mickey Mouse figure lights up the following address numbers n, number 71˜75, numbers 126˜133, numbers 181˜190, numbers 237˜241, number 243,245,246, numbers 288˜302, numbers 342˜359, numbers 398˜415, numbers 455˜459, numbers 462˜470, numbers 518˜523, numbers 573˜580, numbers 629˜636, and numbers 687˜691. The controller CL, based on the command, signals the LED with the above mentioned address numbers n, to light up with the same color, or change color over time, or gradually partially change the color of the figure, or dimmer the brightness of the figure or change the location of the figure. Address number 242 and 244, as the eyes of the figure, will not light up, but the LED's outside of the figure area can either not light up, or light up with a different color as the Mickey Mouse figure, or gradually partially change color, or alternate dimmer and light up to display the Mickey Mouse Figure on Tree 2, with the effect that cannot be achieved with the traditional method.

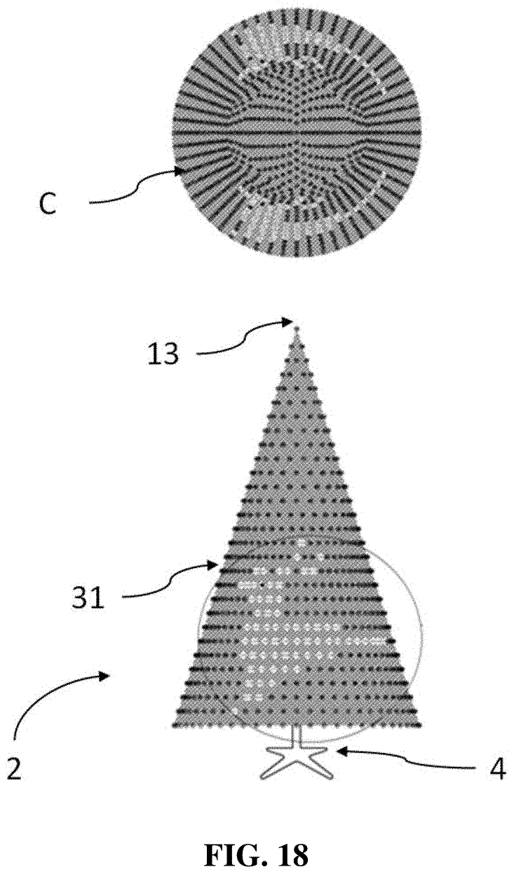

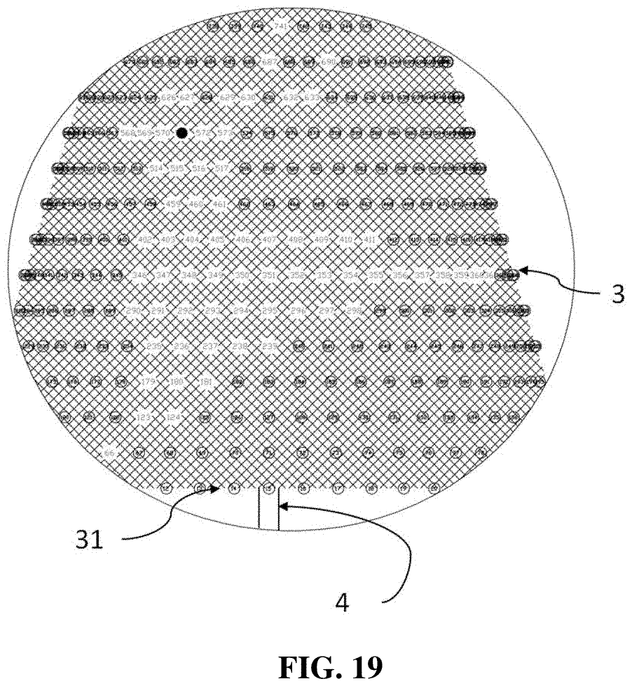

Implementation 2: Please refer to FIGS. 18 and 19 for the following implementation example, this example shows a display of a Deer, where the command to present the Deer figure is set, and a signal is sent to LEDs with specific addresses to light up, said Deer figure lights up the following address numbers n, number 66, number 123˜124, numbers 179˜181, numbers 235˜239, numbers 290˜298, number 346˜361, numbers 402˜411, numbers 459˜461, numbers 514˜517, numbers 568˜570, number 571, numbers 572˜573, numbers 626˜627, numbers 629˜630, and numbers 632˜633, numbers 687,690, and 741. The controller CL, based on the command, signals the LED with the above mentioned address numbers n, to light up with the same color, or change color over time, or gradually partially change the color of the figure, or dimmer the brightness of the figure or change the location of the figure. Address number 571, as the eyes of the figure, will not light up, but the LED's outside of the figure area can either not light up, or light up with a different color as the Deer figure, or gradually partially change color, or alternate dimmer and light up to display the Deer Figure on Tree 2, with the effect that cannot be achieved with the traditional method.

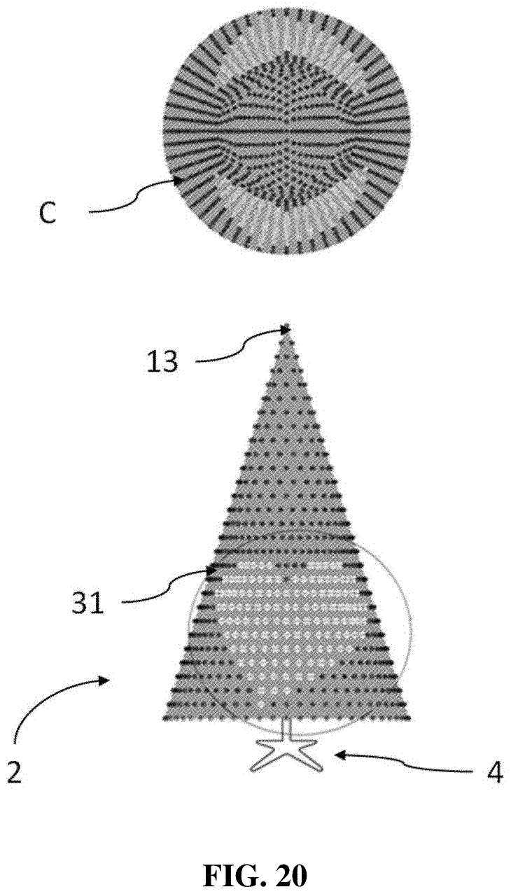

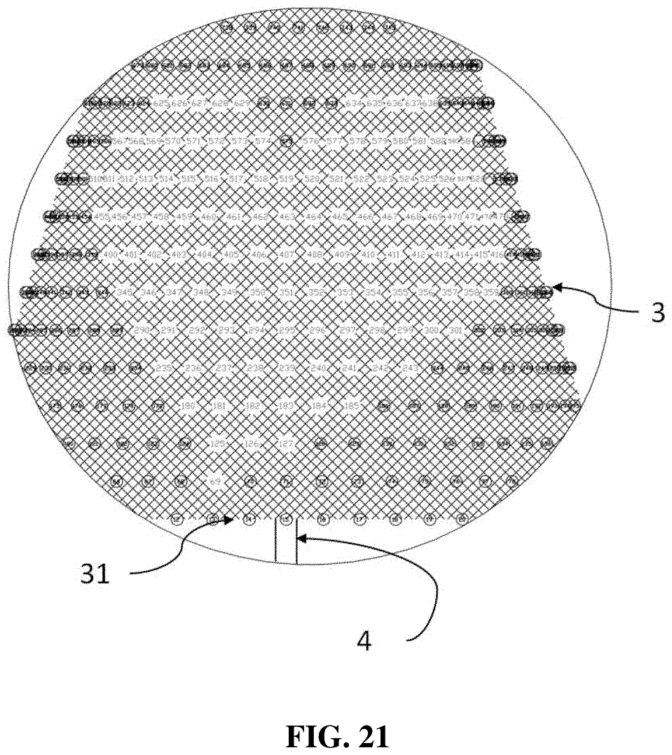

Implementation 3: Please refer to FIGS. 20 and 21 for the following implementation example, this example shows a display of a Hart, where the command to present the Hart figure is set, and a signal is sent to LEDs with specific addresses to light up, said Hart figure lights up the following address numbers n, number 69, number 125˜127, numbers 180˜185, numbers 235˜243, numbers 290˜301, number 345˜359, numbers 400˜416, numbers 455˜473, numbers 510˜528, numbers 567˜574, numbers 576˜584, numbers 625˜629, and numbers 634˜638. The controller CL, based on the command, signals the LED with the above mentioned address numbers n, to light up with the same color, or change color over time, or gradually partially change the color of the figure, or dimmer the brightness of the figure or change the location of the figure. The LED's outside of the figure area can either not light up, or light up with a different color as the Hart figure, or gradually partially change color, or alternate dimmer and light up to display the Hart Figure on Tree 2, with the effect that cannot be achieved with the traditional method.

Implementation 4: Is the method of using algorithms to show the animation of left and right movement of figures. First set the required LED addresses required for the animation in the controller CL, then using the controller CL to control the LEDs' color and brightness. If all the address number N that needs to light up for the figures, is represented as n+1, the whole figure would shift rightward by 1 unit; oppositely if all the numbers were represented by n−1, the figure would shift leftward by one unit. The previously mentioned address numbers increase by 1 per 0.1 seconds, the figure would continuously shift right, similarly, if the address numbers decrease by 1 per 0.1 seconds, the figure would continuously shift left and animate the figures or words. If the address number, after being increased or decreased by 1, is located between the first of last address on its light layer 31, then the address number is correct; if any address number is larger than the last address number of that light layer 31 after increasing by 1, then that address number must subtract the total number of address numbers on said light layer 31 to reach the correct address number. If any address number is smaller than the first address number of that light layer 31 after decreasing by 1, then that address number must add the total number of address numbers on said light layer 31 to reach the correct address number. In this example, each slope light layer LAY, Layer 0˜Layer 12 each has 56 LED bulbs, and Layer 2's address number n is 113˜168, hence the starting number is 113 and the ending number is 168. So in layer 2 when the original address number 168 becomes 169 after increasing by 1, which is larger than the last address number 168, so the address number must subtract by 56, and becomes 113 (169−56=113), and returns to the starting number 113 to fit the range of the address number of said layer. So in layer 2 when the original address number 113 becomes 112 after decreasing by 1, which is smaller than the first address number 113, so the address number must increase by 56, and becomes 168 (112+56=168), and becomes the ending address number 168 to fit the range of the address number of said layer.

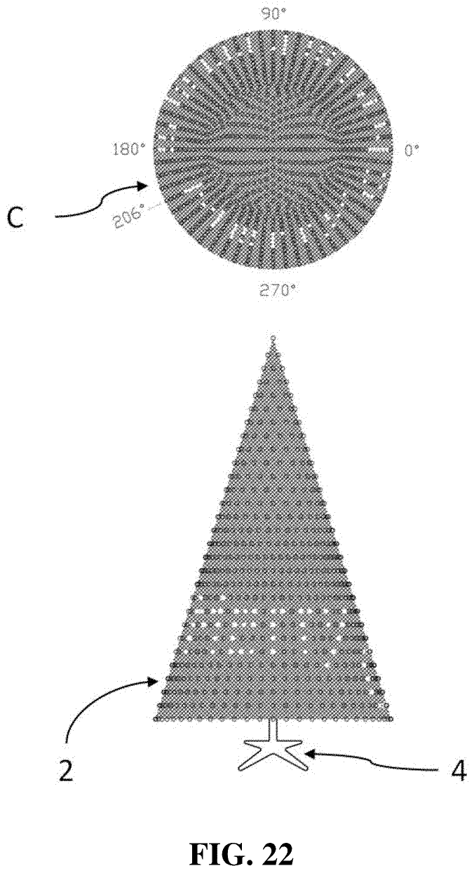

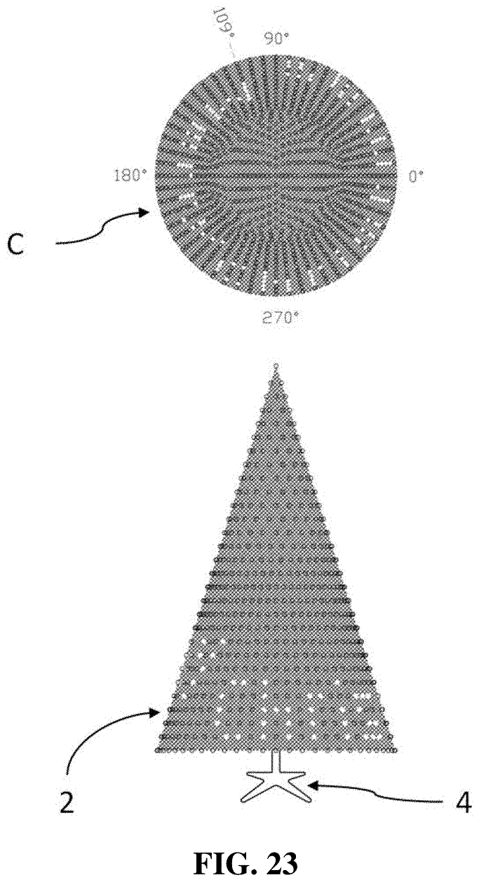

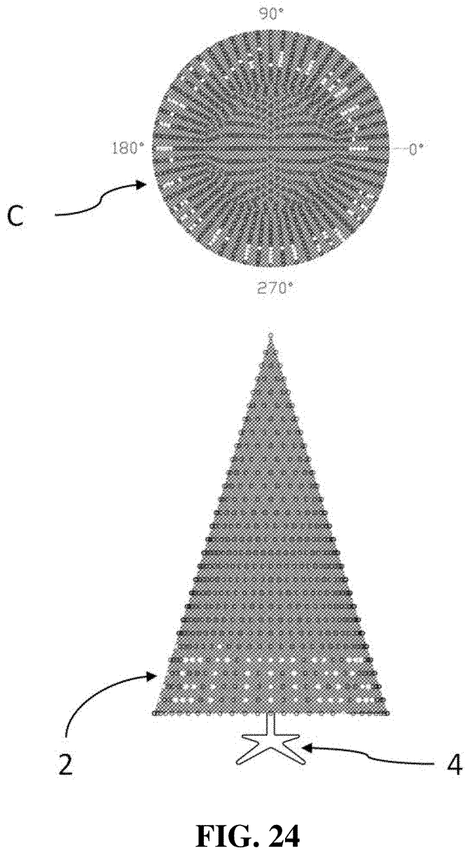

Implementation 5: Please refer to FIGS. 22 to 24 for this implementation of this invention, presenting the animation of words and figures. In FIG. 22, the word “Marry” of “Marry Christmas” is shown with the view angel A of 206 degrees, showing the word “Marry” in the front view, then using the pillar 4 of Tree 2 as the center, the figure would move in the clockwise direction as shown in FIG. 23, the word “Marry” is at the view angle A of 109 degrees, and in the front view shows the word “Chris”. Furthermore in FIG. 24, the word “Marry” has rotated to view angle A of 0 degrees, while the front view shows “st mas” to complete one rotation of the phrase, and while the phrase was rotating, the words can gradually change colors at random moments, while the addresses outside of the letters can flash alternatively to beautify the view. Hence once this invention is implemented in the artificial tree market, the tree will be able to present multiple types of figures, words and animations, and improve the holiday atmosphere.

1. A new type Artificial Tree comprising:
a light string having RGB, WRGB or WWRGB LEDs each containing an individual built-in address chips;
a controller having settings that would control a lights brightness, dimmer, and color change; and
a tree having a pillar to hold the tree and the light strings or light layers,
wherein the new type artificial tree can present different words of figures or a combination of words and figures which can be animated to improve holiday atmosphere.

2. A new type artificial tree according to claim 1, wherein the light string has RGB LED with built-in individual address chips, circulating each light layer of the tree.

3. A new type of artificial tree according to claim 1, wherein the controller can be a remote controller, a cellular phone, a computer application, allowing the controller to input electric power and command to control the brightness and color of the display.

4. A new type of artificial tree according to claim 1, wherein the controller can control each individual or multiple light's brightness and color change.

5. A new type of artificial tree according to claim 3, wherein the controller can control each individual or multiple light's brightness and color change.

6. A new type of artificial tree according to claim 1, wherein the LED on the light string is RGB, WRGB or WWRGB LEDs each containing an individual built-in address chips.

7. A new type of artificial tree according to claim 2, wherein the LED on the light string is RGB, WRGB or WWRGB LEDs each containing an individual built-in address chips.

8. A new type artificial tree according to claim 1, wherein the LED can either be case-less or cased or light guiding optic fiber or other light guiding material.

9. A new type artificial tree according to claim 1, wherein the tree is divided into multiple light layers, while each light layer can be horizontal parallel to the floor or sloped, each layer is then number as Layer 0, Layer 1, Layer 2˜Layer n, while the light string fix around the tree circulating each light layer's either exterior circumference or interior circumference.
